(19) United States
(12) Patent Application Publication
(10) Pub. No.: US 2001/0021473 A1
(43) Pub. Date: Sep. 13, 2001

(54) Production of moldings for lithium ion batteries

(75) Inventors: Stephan Bauer, Hochdorf-Assenheim (DE); Bernd Bronstert, Otterstadt (DE); Uwe Burkhardt, Frankenstein (DE); Franz Weingart, Leimen (DE); Thomas Kessler, Schifferstadt (DE); Helmut Mohwald, Annweiler (DE); Florian Hennenberger, Limburgerhof (DE)

Correspondence Address: GREENBLUM & BERNSTEIN, 1941 ROLAND CLARKE PLACE, RESTON, VA, 20191

(73) Assignee: EMTEC MAGNETICS GmbH, Ludwigsshafen (DE)

(21) Appl. No.: 09/780,500

(22) Filed: Feb. 12, 2001

Related U.S. Application Data
(63) Continuation of application No. 09/048,090, filed on Mar. 26, 1998, now abandoned.

(30) Foreign Application Priority Data
Mar. 27, 1997 (DE) 197 13 046.1

(51) Int. Cl. H01M 2/16; H01M 4/62; H01M 4/58; H01M 6/18

(52) U.S. Cl. 429/231.95; 429/254; 429/316; 429/217; 252/62.2

(57) ABSTRACT

A molding, preferably a film-like molding, is produced by a process which comprises the following stage:

I) Compounding and extruding the melt of a mixture I which comprises a mixture II which contains:

a) from 1 to 95% by weight of at least one pigment III which has a primary particle size of from 5 nm to 20 μm and is selected from the group consisting of an electrochemically inert solid IIIa, a compound IIIb capable of releasing lithium ions on charging and a compound IIIc capable of accepting lithium ions on charging and a mixture of the solid IIIa with the compound IIIb or the compound IIIc,

b) from 5 to 99% by weight of at least one copolymer IV of vinylidene fluoride (VdF) and hexafluoropropylene (HFP) containing from 8 to 25% by weight of HFP and

c) from 1 to 200% by weight, based on the total amount of the components a) and b), of a plasticizer V which is selected from the group consisting of dibutyl phthalate, dimethyl phthalate, diethyl phthalate, tris(butoxyethyl) phosphate, propylene carbonate, ethylene carbonate, trimethyl trimellitate and mixtures of two or more thereof,

the proportion of the mixture II in the mixture I being from 1 to 100% by weight.

The present invention relates to a process for the production of moldings suitable as, inter alia, solid electrolytes, separators and electrodes for electrochemical cells, preferably of film-like moldings for electrochemical cells by melt extrusion; solid electrolytes, separators, electrodes, sensors, electrochromic windows, displays, capacitors and ion-conducting films per se, each of which comprises such a molding; and electrochemical cells having such solid electrolytes, separators and/or electrodes.

Electrochemical, in particular rechargeable cells are generally known, for example from “Ullmann's Encyclopedia of Industrial Chemistry”, 5th Ed., Vol. A3, VCH Verlagsgesellschaft mbH, Weinheim, 1985, pages 343-397.

Among these cells, the lithium batteries and the lithium ion batteries occupy a special position, in particular as secondary cells, owing to their high specific energy storage density.

As described, inter alia, in the above citation from Ullmann, such cells contain, in the cathode, lithium ions and mixed oxides containing manganese, cobalt, vanadium or nickel ions, as may be described in the stoichiometrically simplest case as LiMn₂O₄, LiCoO₂, LiV₂O₅ or LiNiO₂.

These mixed oxides undergo reversible reactions with compounds capable of incorporating lithium ions into their lattice, such as graphite, with elimination of the lithium ions from the crystal lattice, metal ions therein, such as manganese, cobalt or nickel ions, being oxidized. This reaction can be utilized in an electrochemical cell for current storage by separating the compound accepting lithium ions, ie. the anode material, and the lithium-containing mixed oxide, ie. the cathode material, by an electrolyte through which the lithium ions migrate from the mixed oxide into the anode material (charging process).

The compounds suitable for the reversible storage of lithium ions are usually fixed to discharge electrodes by means of a binder.

When the cell is charged, electrons flow through an external voltage source and lithium cations through the electrolyte to the anode material. When the cell is in use, the lithium cations flow through the electrolyte whereas the electrons flow through a useful resistance from the anode material to the mixed oxide (cathode material).

To avoid a short-circuit inside the electrochemical cell, a layer which is electrically insulating but permeable for lithium cations, ie. a solid electrolyte or separator, is present between the two electrodes.

Solid electrolytes and separators are known to consist of a carrier material into which a compound which contains lithium cations, is capable of dissociation and serves for increasing the lithium ion conductivity and usually further additives, such as solvents, are incorporated.

A solid electrolyte is understood as meaning a material which can be used either without a solvent in the electrochemical cells or, where a solvent is used, contains said solvent substantially in physically bound form.

For the production of the solid electrolytes or separators, in general a solution of the carrier material, the compound containing lithium cations and, if required, further additives is applied to a carrier, after which the solvent is evaporated off.

For example, U.S. Pat. No. 5,540,741 and U.S. Pat. No. 5,478,668 propose a copolymer of vinylidene difluoride and hexafluoropropene as carrier material.

For the production of these battery films according to the above publications, solid, plasticizer and binder are dispersed (cf. Table).

| | Anode | Cathode | Separator |
|---|---|---|---|
| Solid | Graphite | LiMn₂O₄ | Aerosil |
| Plasticizer | Dibutyl phthalate | Dibutyl phthalate | Dibutyl phthalate |
| Binder | COPO | COPO | COPO |
| | (PVDF/HFP) | (PVDF/HFP) | (PVDF/HFP) |
| Solvent | Acetone | Acetone | Acetone |
| Extracting | Diethyl ether | Diethyl ether | Diethyl ether |
| agent | | | |

The dispersion is then cast and the film is dried. The plasticizer is then extracted with diethyl ether. The binder is a random copolymer of vinylidene fluoride and hexafluoropropene (8-25%).

The process described there has the following disadvantages:

1. Use of organic solvents

2. Film must be dried

3. Extraction of the plasticizer is required

4. Extracting agent is explosive

5. Plasticizer is not completely extracted from the film.

It is an object of the present invention to provide an improved process for the production of such moldings, and these moldings per se which, owing to the production process, have a particular microstructure and improved mechanical properties.

Owing in particular to the presence of a pigment III and the special process parameters used here and as defined below, moldings are obtained which, when used as solid electrolyte, separator or electrode, have improved short-circuit resistance, higher compressive strength, in particular at elevated temperatures above 120° C., and greater porosity compared with the systems known to date and moreover are capable of permanently suppressing the formation of Li dendrites. Furthermore, the presence of the pigment results in improved cycle stability and a higher current-carrying capacity of an electrochemical cell. Furthermore, when the preferably employed basic solids IIIa are used, the acid formed during the operation of an electrochemical cell is trapped or neutralized.

We have found that this object is achieved by a process for the production of a molding, preferably of a film-like molding, which comprises the following stage:

I) Compounding and extruding the melt of a mixture I which comprises a mixture II which contains:

a) from 1 to 95% by weight of at least one pigment III which has a primary particle size of from 5 nm to 20 μm and is selected from the group consisting of an electrochemically inert solid IIIa, a compound IIIb capable of releasing lithium ions on charging and a compound IIIc capable of accepting lithium ions on charging and a mixture of the solid IIIa with the compound IIIb or the compound IIIc,

b) from 5 to 99% by weight of at least one copolymer IV of vinylidene fluoride (VdF) and hexafluoropropylene (HFP) containing from 8 to 25% by weight of HFP and

c) from 1 to 200% by weight, based on the total amount of the components a) and b), of a plasticizer V which is selected from the group consisting of dibutyl phthalate, dimethyl phthalate, diethyl phthalate, tris(butoxyethyl) phosphate, propylene carbonate, ethylene carbonate, trimethyl trimellitate and mixtures of two or more thereof,

the proportion of the mixture II in the mixture I being from 1 to 100% by weight.

The present invention furthermore relates to a process, as defined above, wherein the pigment III is an electrochemically inert solid IIIa which is selected from the group consisting of an inorganic solid, preferably an inorganic basic solid, selected from the group consisting of oxides, mixed oxides, carbonates, silicates, sulfates, phosphates, amides, imides, nitrides and carbides of the elements of main group I, II, III or IV or subgroup IV of the Periodic Table; a polymer selected from the group consisting of polyethylene, polypropylene, polystyrene, polytetrafluoroethylene, polyvinylidene fluoride, polyamides and polyimides; a solid dispersion containing such a polymer; and a mixture of two or more thereof, the resulting molding is suitable as a solid electrolyte and/or separator.

The following are particular examples: oxides, such as silica, alumina, magnesium oxide or titanium dioxide, mixed oxides, for example the elements silicon, calcium, aluminum, magnesium and titanium; silicates, such as ladder silicates, chain silicates, sheet silicates and framework silicates; sulfates, such as alkali metal sulfates and alkaline earth metal sulfates; carbonates, for example alkali metal carbonates and alkaline earth metal carbonates, such as calcium carbonate, magnesium carbonate or barium carbonate or lithium carbonate, potassium carbonate or sodium carbonate; phosphates, for example apatites; amides; imides; nitrides; carbides; polymers, such as polyethylene, polypropylene, polystyrene, polytetrafluoroethylene, polyvinylidene fluoride, polyamides, polyimides or other thermoplastics, duromers or microgels, solid dispersions, in particular those which contain the abovementioned polymers, and mixtures of two or more of the abovementioned solids.

Basic solids are particularly suitable. Basic solids are intended to be understood as meaning those whose mixture with a liquid, water-containing diluent which has a pH of not more than 7 possesses a higher pH than this diluent.

The solids should advantageously be substantially insoluble in the liquid used as an electrolyte and should be electrochemically inert in the battery medium.

Furthermore, the present invention relates to a process wherein the pigment III is a compound IIIb which is capable of releasing lithium ions on charging and is selected from the group consisting of LiCoO₂, LiNiO₂, LixMnO₂ (0<x≦1), LiₓMn₂O₄ (0<x≦2), LiₓMoO₂ (0<x≦2), LiₓMnO₃ (0<x≦1), LiₓMnO₂(0<x≦2), LiₓMn₂O₄ (0<x≦2), LiₓV₂O₄ (0<x≦2.5), LiₓV₂O₃ (0<x≦3.5), LiₓVO₂ (0<x≦1), LiₓWO₂ (O<x<l), LiₓWO₃ (0<x≦1), LiₓTiO₂ (0<x≦1), LiₓTi₂O₄ (0<x≦2), LiₓRuO₂ (0<x≦1), LiₓFe₂O₃ (0<x≦2), LiₓFe₃O₄ (0<x≦2), LiₓCr₂O₃ (0<x≦0), LiₓCr₃O₄ (0<x≦3.8), LiₓV₃S₅ (0<x≦1.8), LiₓTa₂S₂ (0<x≦1), LiₓFeS (0<x≦1), LiₓFeS₂ (0<x≦1), LiₓNbS₂ (0<x≦2.4), LiₓMoS₂ (0<x≦3), LiₓTiS₂ (0<x≦2), LiₓZrS₂ (0<x≦2), LiₓNbSe₂ (0<x≦3), LiₓVSe₂ (0<x≦1), LiₓNiPS₂ (0<x≦1.5), LiₓFePS₂ (0<x≦1.5), a mixture of two or more thereof and a mixture of the compound IIIb with the solid IIIa, and the mixture I additionally contains from 0.1 to 20% by weight, based on the mixture II, of conductive carbon black, it being possible for the molding obtained to be used in particular as a cathode.

The present invention furthermore relates to a process wherein the pigment III is a compound IIIc which is capable of accepting lithium ions on charging and is selected from the group consisting of lithium, a lithium-containing metal alloy, micronized carbon black, natural and synthetic graphite, synthetically graphitized carbon dust, a carbon fiber, titanium oxide, zinc oxide, tin oxide, molybdenum oxide, tungsten oxide, titanium carbonate, molybdenum carbonate, zinc carbonate, a mixture of two or more thereof and a mixture of the compound IIIc with the solid IIIa, and the mixture I additionally contains up to 20% by weight, based on the mixture II, of conductive carbon black, it being possible for the molding obtained to be used in particular as an anode.

Pigments III which have a primary particle size of from 5 nm to 20 μm, preferably from 0.01 to 10 μm, in particular from 0.1 to 5 μm, are particularly suitable, the stated particle sizes being determined by electron microscopy. The melting point of the pigments is preferably above the operating temperature usual for the electrochemical cell, melting points above 120° C., in particular from 150° C., having proven especially advantageous.

The pigments may be symmetrical with regard to their external shape, ie. may have a height:width:length ratio (aspect ratio) of about 1 and may be present as spheres, granules or roughly round structures or in the form of any desired polyhedra, for example as cuboids, tetrahedra, hexahedra, octahedra or bipyramids, or may be distorted or asymmetrical, ie. may have a height:width:length ratio (aspect ratio) which is not equal to 1 and may be present, for example, as needles, asymmetric tetrahedra, asymmetric bipyramids, asymmetric hexahedra or octahedra, lamellae, disks or fibrous structures. If the solids are present as asymmetric particles, the abovementioned upper limit for the primary particle size is based on the smallest axis in each case.

In the production of the moldings which may be used as a cathode or anode, the conductive carbon black, where present, is preferably added in the form of a masterbatch to the mixture II. The masterbatch is a composition which contains from 20 to 50% by weight of conductive carbon black, from 5 to 30% by weight of polymeric binder IV and from 30% to 75% by weight of plasticizer V. The amount and composition of the masterbatch is chosen so that the total amount of conductive salt added does not exceed 20% by weight, based on the mixture II. The masterbatch is preferably prepared by compounding and extruding a melt of the abovementioned components.

According to the invention, the mixtures II should comprise from 1 to 95%, preferably from 25 to 90, in particular from 30 to 70, % by weight of a pigment III and from 5 to 99, preferably from 10 to 75, in particular from 30 to 70, % by weight of a copolymer IV, the copolymer IV advantageously having a number average molecular weight of from 5000 to 100,000,000, preferably from 50,000 to 8,000,000.

The following further starting materials are used in the production of the molding or in the mixture I used or the mixture II:

Copolymers of vinylidene fluoride (VdF) and hexafluoropropylene (HFP) containing from 8 to 25% by weight of HFP are used as copolymer IV. These copolymers are known per se, inter alia from U.S. Pat. No. 5,540,741 and U.S. Pat. No. 5,478,668 mentioned at the outset.

Dibutyl phthalate, dimethyl phthalate, diethyl phthalate, tris(butoxyethyl) phosphate, propylene carbonate, ethylene carbonate, trimethyl trimellitate and mixtures of two or more thereof may be used as plasticizer V.

The amount of plasticizer is from 1 to 200, preferably from 10 to 100, % by weight, based on the total weight of the pigment III and of the polymeric binder IV.

The conductive salts which are generally known and described, for example, in EP-A 96 629 may be used as conductive salts. Compounds such as LiPF₆, LiAsF₆, LiSbF₆, LiClO₄, LiN(CF₃SO₂)₂, LiBF₄ or LiCF₃SO₃ and mixtures of such compounds are particularly suitable. These conductive salts are used in amounts of from 0.1 to 50, preferably from 1 to 10, % by weight, based in each case on the novel mixture.

If required, dispersing resins may be added in order to improve the dispersing of the pigments, as described in EP 940197.

Suitable carrier material for the moldings produced according to the invention are the materials usually used for electrodes, preferably metals, such as aluminum and copper. Temporary substrates, such as films, in particular polyester films, such as polyethylene terephthalate films, may also be used.

Such films can advantageously be provided with a release layer, preferably of polysiloxanes.

Furthermore, the mixtures used according to the invention may be crosslinked in a manner known per se after or during the extrusion of the melt, preferably thereafter.

This is done, for example, by exposure to ionic or ionizing radiation, an electron beam, preferably having an accelerating voltage of from 20 to 2000 kV and a radiation dose of from 5 to 50 Mrad, or UV or visible light, an initiator, such as benzil dimethyl ketal or 1,3,5-trimethylbenzoyltriphenyl phosphine oxide usually advantageously being added in amounts of, in particular, not more than 1% by weight, based on the polymeric binder, and it being possible to carry out the crosslinking in the course of, in general, from 0.5 to 15 minutes, advantageously under inert gas, such as nitrogen or argon, by thermal free radical polymerization, preferably at above 60° C., an initiator, such as azobisisobutyronitrile, advantageously being added in amounts of, in general, not more than 5, preferably from 0.05 to 1, % by weight, based on the polymeric binder, by electrochemically induced polymerization or by ionic polymerization, for example by acid-catalyzed cationic polymerization, suitable catalysts being primarily acids, preferably Lewis acids, such as BF₃ or in particular LiBF₄ or LiPF₆. Catalysts containing lithium ions, such as LiBF₄ or LiPF₆, can advantageously remain in the solid electrolyte or separator as a conductive salt.

The present invention furthermore relates to a molding, preferably a film-like molding, obtainable by a process which comprises the following stage:

I) Compounding and extruding the melt of a mixture I which, comprises a mixture II which contains:

a) from 1 to 95% by weight of at least one pigment III which has a primary particle size of from 5 nm to 20 μm and is selected from the group consisting of an electrochemically inert solid IIIa, a compound IIIb capable of releasing lithium ions on charging and a compound IIIc capable of accepting lithium ions on charging, and a mixture of the solid IIIa with the compound IIIb or the compound IIIc,

b) from 5 to 99% by weight of at least one copolymer IV of vinylidene fluoride (VdF) and hexafluoropropylene (HFP) containing from 8 to 25% by weight of HFP and

c) from 1 to 200% by weight, based on the total amount of the components a) and b), of a plasticizer V which is selected from the group consisting of dibutyl phthalate, dimethyl phthalate, diethyl phthalate, tris(butoxyethyl) phosphate, propylene carbonate, ethylene carbonate, trimethyl trimellitate and mixtures of two or more thereof,

the proportion of the mixture II in the mixture I being from 1 to 100% by weight.

The present invention furthermore relates to a composite, preferably in the form of a film, particularly preferably in the form of a film having a total thickness of from 15 to 1500 μm, in particular from 50 to 500 μm, obtainable by a process which comprises the following stages:

(I) production of at least one first layer by compounding and extruding the melt of a mixture I as defined above, which comprises a mixture II which contains a solid IIIb or a solid IIIc, each as defined above;

(II) production of at least one second layer by compounding and extruding the melt of a mixture I as defined above, which comprises a mixture II which contains a solid IIIa, as defined herein, and is free of a solid IIIb or a solid IIIc, and

(III) subsequent combination of the one or more first layers with the one or more second layers by a conventional coating method.

The present invention furthermore relates to a process for the production of such a composite, which comprises the following stages:

(I) production of at least one first layer by compounding and extruding the melt of a mixture I as defined above, which comprises a mixture II which contains a solid IIIb or a solid IIIc, each as defined above,

(II) production of at least one second layer by compounding and extruding the melt of a mixture I as defined above, which comprises a mixture II which contains a solid IIIa, as defined herein, and is free of a solid IIIb or a solid IIIc, and

(III) subsequent combination of the one or more first layers with the one or more second layers by a conventional coating method.

Preferably, the one or more second layers are produced on a temporary substrate. According to the invention, conventionally used temporary substrates, for example a release film comprising a polymer or a preferably coated paper, for example a siliconized polyester film, may be used. However, the production of this second layer is also possible on a permanent substrate, for example a discharge electrode, or completely without a substrate. This layer may be extruded either together with the substrate or directly onto said substrate.

The combination or the production of the layers defined above is carried out by methods for coating or producing films under atmospheric pressure, for example casting or knife coating, and by processing methods under pressure, for example extrusion, coextrusion, lamination, backing, calendering or pressing. If required, the composite film produced in this manner can be electrochemically or thermally crosslinked or cured by means of radiation.

As is evident from the above, it is therefore readily possible to provide a composite having the components release film/separator (second layer)/electrode (first layer).

It is also possible to provide a composite having the components anode/separator/cathode by double-sided coating.

Filling such composites with an electrolyte and conductive salt can be carried out either before combination or, preferably, after combination of the layers, if necessary after contact with suitable discharge electrodes, for example a metal foil, or even after the introduction of the layers into a battery casing, the special microporous structure of the layers permitting with the use of the novel mixture, in particular owing to the presence of the solid defined above in the separator and, if required, in the electrodes, the absorption of the electrolyte and of the conductive salt and the displacement of the air in the pores. The filling may be carried out at from 0 to about 100° C., depending on the electrolyte used.

The moldings are produced by compounding and melt extrusion, preferably at from about 50 to about 250° C.

Preferably used apparatuses for the extrusion are a single-screw plasticating extruder, for example a single-screw Berstorff mixer-extruder, a Frenkel mixer, a plasticator or a Buss-Ko kneader, a twin-screw extruder of the corotating or counterrotating type, for example an extruder having COLOMBO screws, an extruder having closely intermeshing ZSK screws, an extruder having Holo-Flite twin screws, a Leistritz kneader pump, an extruder having Pasquetti twin screws, an extruder having Cotruder screws, an extruder of the Kestermann type, an extruder having Mapre twin screws, a GETECHA kneader-extruder, an Anger tandem extruder, a Zimmermann-Jansen extruder, a continuous twin-screw kneader, for example a DSM twin-screw mixer, an Eck mixtruder, an FCM kneader or a List all-phase apparatus or a continuous multiscrew extruder, for example a four-screw extruder or a planetary extruder, or a combination of two or more thereof.

Particularly preferred apparatuses are single-screw and twin-screw apparatuses, for example single-screw mixer-extruders (Reifenhauser, Krauss Maffei, Berstorff), corotating or counterrotating, closely intermeshing twin-screw kneaders (Werner and Pfleiderer, Berstorff, APV), multiscrew extruders, Buss-Ko kneaders or counterrotating, non-intermeshing kneaders (Farrel, JSW).

Screws and barrels of the continuously operated ZSK 30 extrusion line are of modular design. For sufficient plastication, dispersing and homogenization of the individual components, the process section consists of not more than 15 barrel zones, corresponding to 45 units of length per diameter. Each zone is separately equipped with an electric heater. The barrels are cooled with compressed air or water.

The screw consists of a plurality of conveying, plasticating and mixing zones. A special configuration of different kneading and mixing elements is required for gentle, homogeneous dispersion of the solids, explicitly of the inorganic pigments, in the polymeric binder.

If the novel molding is to be used as a solid electrolyte in an electrochemical cell, a compound containing lithium cations and capable of dissociation, ie. a conductive salt as defined above, and further additives, in particular organic solvents, ie. an electrolyte, should be incorporated.

These substances may be partially or completely mixed with the suspension during the production of the layer or may be introduced into the layer after the production of the layer.

Suitable organic electrolytes are the compounds discussed above under plasticizer V, the conventional organic electrolytes, preferably esters, such as ethylene carbonate, propylene carbonate, dimethyl carbonate and diethyl carbonate, or mixtures of such compounds preferably being used.

Novel solid electrolytes, separators and/or electrodes suitable for electrochemical cells should advantageously have a thickness of from 5 to 500 μm, preferably from 10 to 500 μm, particularly preferably from 10 to 200 μm, in particular from 20 to 100 μm.

The present invention also relates to a process for the production of a solid electrolyte, of a separator, of an electrode, a sensor, an electrochromic window, a display, a capacitor or an ion-conducting film comprising the incorporation of a molding as described above.

As is evident from the above, the present invention also relates to the use of a novel molding or composite or of a molding or composite produced by means of a novel process for the production of a solid electrolyte, of a separator, of an electrode, in a sensor, in an electrochromic window, in a display, in a capacitor or in an ion-conducting film.

The present invention furthermore relates to a separator, a solid electrolyte, an electrode, a sensor, an electrochromic window, a display, a capacitor or an ion-conducting film comprising a novel molding or composite, or a molding or composite produced according to the invention, and an electrochemical cell, comprising a separator, a solid electrolyte or an electrode as defined above, or a combination of two or more thereof.

This electrochemical cell can be used in particular as a car battery, apparatus battery or flat-type battery.

Thus, the present invention also relates to a car battery, apparatus battery or flat-type battery comprising an electrochemical cell as described above.

### EXAMPLES

Three Figures are attached to this Application to illustrate the basic sequences within the novel process.

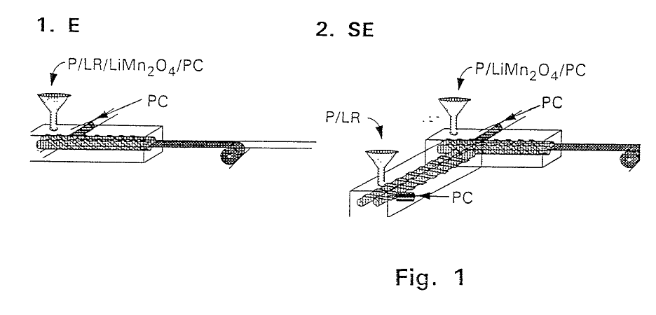

FIG. 1 shows a schematic representation of the production of a cathode film by means of an extruder (E) and an extruder with side extruder (SE);

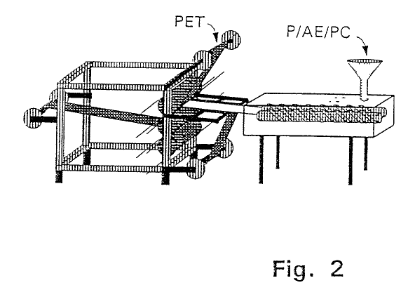

FIG. 2 shows a schematic representation of the coextrusion of a mixture used according to the invention, together with a PET film;

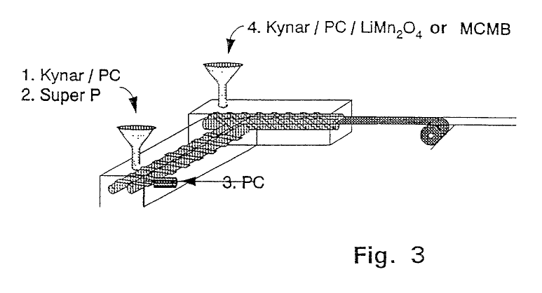

FIG. 3 shows a schematic representation of the production of a cathode film (LiMn₂O₄) or anode film (MCMB).

First, the principles of the novel production process, as shown schematically in FIG. 1, are to be described for, by way of example, a corotating, closely intermeshing ZSK 30 twin-screw kneader from Werner and Pfleiderer.

The corotating and closely intermeshing and hence self-purging extruder consists of a plurality (up to 15) of variable installable individual zones which can be heated by means of heating loops.

Addition of the components:

a) The polymers (P) were homogeneously distributed with the pigment and part of the plasticizer in a fluid mixer. The addition was effected by means of a metering balance. If necessary, the extruder was flushed with nitrogen to provide an inert atmosphere.

b) The plasticizer was, if required, metered by means of a metering pump into the melting zone of the extruder.

c) The conductive carbon black (LR) was metered into the melt phase by means of a side extruder. The side extruder was a single-screw or twin-screw extruder. If desired, a homogeneous melt of polymer, plasticizer and conductive carbon black and, if required, dispersing resin was produced in the side extruder and fed into the side of the mixing extruder.

The film was extruded via a sheet die and calendered. If desired, the film was coextruded between two films (eg. polyethylene terephthalate) (FIG. 2). The thickness of the battery films was 10-1000 μm.

The following may be mentioned as advantages of the novel production process:

1. Solvent is dispensed with

2. Drying of the battery films is dispensed with

3. Extraction and extraction solvents are dispensed with

4. The film can be installed in the battery without further pretreatment

5. More homogeneous distribution of the pigments

6. Better mechanical stability of the films (compared with films produced by casting technology).

### EXAMPLE 1

### Production of a cathode film

| | |
|---|---|
| 4910 g | of LiMn₂O₄ |
| 1310 g | of polyvinylidene fluoride-co-hexafluoropropene |
| | Kynar ® 2801 (Elf Atochem) |
| 1030 g | of Super ® P (MMM Carbon) conductive carbon black |
| 2740 g | of propylene carbonate (PC) |

Composition of the extruder:

Corotating ZSK 30 twin-screw main extruder having 10 variable heatable zones. A corotating twin-screw ZSK 30 side extruder having 6 variable heatable zones was attached to the fourth zone.

Production:

180 g/h of a mixture of 100 parts of Kynar® 2801, 5 parts of propylene carbonate and 442 g/h of Super® P conductive carbon black were metered into the first zone of the ZSK 30 side extruder. Furthermore, 1075 g/h of propylene carbonate were pumped into the melting zone (zone 2) of the side extruder. This melt was fed to the melting zone (zone 4) of the main extruder. In addition, 2600 g of a mixture of 15.1 parts of Kynar® 2801, 81.1 parts of LiMn₂O₄ and 3.8 parts of propylene carbonate were metered into the first zone of the main extruder. The internal temperature in the two extruders was 150° C. The melt was extruded via a heatable sheet die (150° C.) having a slit width of 5 mm and was coextruded between two PET films and then calendered.

The film obtained had the following properties:

| | | |
|---|---|---|
| Surface resistance: | 140 | ohm |
| Film thickness: | 100-500 | μm |

### EXAMPLE 2

### Production of an anode film

Composition:

| | |
|---|---|
| 5600 g | of MCMB (Osaka Gas) |
| 1500 g | of polyvinylidene fluoride-co-hexafluoropropene |
| | Kynar ® 2801 (Elf Atochem) |
| 400 g | of Super ® P (MMM Carbon) conductive carbon black |
| 2500 g | of propylene carbonate |

Composition of the extruder, cf. Example 1

Production:

180 g/h of a mixture of 100 parts of Kynar® 2801, 5 parts of propylene carbonate and 150 g/h of Super® P conductive carbon black were metered into the first zone of the ZSK 30 side extruder. Furthermore, 841 g/h of propylene carbonate were pumped into the melting zone (zone 2) of the side extruder. This melt was fed to the melting zone (zone 4) of the main extruder.

In addition, 2600 g of a mixture of 15.1 parts of Kynar® 2801, 80.8 parts of MCMB and 3.4 parts of propylene carbonate were metered into the first zone of the main extruder. The internal temperature in the two extruders was 150° C.

The melt was extruded via a heatable sheet die (150° C.) having a slit width of 5 mm and was coextruded between two PET films and then calendered.

The film obtained had the following properties:

| | |
|---|---|
| Surface resistance: | 80 ohm |
| Film thickness: | 50-300 μm |

### EXAMPLE 3

### Production of a separator film

Composition:

| | |
|---|---|
| 3000 g | of polyvinylidene fluoride-co-hexafluoropropene |
| | Kynar ® 2801 (Elf Atochem) |
| 2000 g | of Aerosil ® R 812 (Degussa) (AE) |
| 5000 g | of propylene carbonate |

Production:

4500 g/h of a mixture of 30 parts of Kynar® 2801, 20 parts of Aerosil® R 812 and 50 parts of propylene carbonate were metered into a corotating ZSK 40 twin-screw extruder having 10 variable heatable zones. The internal temperature in the extruder was 150° C. The melt was extruded via a heatable sheet die having a slit width of 1 mm and was coextruded between two PET films and then calendered.

The film obtained had the following film thickness:

Film thickness: from 20 to 100 μm.

### EXAMPLE 4

A composite having the following structure was produced from the cathode film according to Example 1, the anode film according to Example 2 and the separator film according to Example 3, by lamination at 140° C.:

Cathode film/metal lattice foil (aluminum)/cathode film

Separator film

Anode film/metal lattice foil (copper)/cathode film.

The composite was immersed for half an hour in a 1 molar solution of LiPF₆ in dimethyl carbonate/ethylene carbonate and then introduced into the flat-type battery casing. The composite had good resistance to swelling.

### CROSS-REFERENCE TO RELATED APPLICATION

The present application claims priority under 35 U.S.C. § 119 of German Patent Application No. 197 13 046.1, filed Mar. 27, 1997, the disclosure of which is expressly incorporated by reference herein in its entirety.

We claim:

1. A process for the production of a molding, preferably of a film-like molding, which comprises the following stage:
I) compounding and extruding the melt of a mixture I which comprises a mixture II which contains:
a) from 1 to 95% by weight of at least one pigment III which has a primary particle size of from 5 nm to 20 μm and is selected from the group consisting of an electrochemically inert solid IIIa, a compound IIIb capable of releasing lithium ions on charging and a compound IIIc capable of accepting lithium ions on charging and a mixture of the solid IIIa with the compound IIIb or the compound IIIc,
b) from 5 to 99% by weight of at least one copolymer IV of vinylidene fluoride (VdF) and hexafluoropropylene (HFP) containing from 8 to 25% by weight of HFP and
c) from 1 to 200% by weight, based on the total amount of the components a) and b), of a plasticizer V which is selected from the group consisting of dibutyl phthalate, dimethyl phthalate, diethyl phthalate, tris(butoxyethyl) phosphate, propylene carbonate, ethylene carbonate, trimethyl trimellitate and mixtures of two or more thereof,
the proportion of the mixture II in the mixture I being from 1 to 100% by weight.

2. A process as claimed in claim 1, wherein the pigment III is a solid IIIa which is selected from the group consisting of an inorganic solid, preferably an inorganic basic solid, selected from the group consisting of oxides, mixed oxides, silicates, sulfates, carbonates, phosphates, nitrides, amides, imides and carbides of the elements of main group I, II, III or IV or subgroup IV of the Periodic Table; a polymer selected from the group consisting of polyethylene, polypropylene, polystyrene, polytetrafluoroethylene and polyvinylidene fluoride; polyamides; polyimides; and a solid dispersion containing such a polymer; and a mixture of two or more thereof.

3. A process as claimed in claim 1, wherein the pigment III is a compound IIIb which is capable of releasing lithium ions on charging and is selected from the group consisting of LiCoO₂, LiNiO₂, LixMnO₂ (0<x≦1), LiₓMn₂O₄ (0<x≦2), LiₓMoO₂ (0<x≦2), LiₓMnO₃ (0<x≦1), LiₓMnO₂ (0<x≦2), LiₓMn₂O₄ (0<x≦2), LiₓV₂O₄ (0<x≦2.5), LiₓV₂O₃ (0<x≦3.5), LiₓVO₂ (0<x≦1), LiₓWO₂ (0<x≦1), LiₓWO₃ (0<x≦1), LiₓTiO₂ (0<x≦1), LiₓTi₂O₄ (0<x≦2), LiₓRuO₂ (0<x≦1); LiₓFe₂O₃ (0<x≦2), LiₓFe₃O₄ (0<x≦2), LiₓCr₂O₃ (0<x≦3), LiₓCr₃O₄ (0<x≦3.8), LiₓV₃S₅ (0<x≦1.8), LiₓTa₂S₂ (0<x≦1), LiₓFeS (0<x≦1), LiₓFeS₂ (0<x≦1), LiₓNbS₂ (0<x≦2.4), LiₓMoS₂ (0<x≦3), LiₓS₂ (0<x≦2), LiₓZrS₂ (0<x≦2), LiₓNbSe₂ (0<x≦3), LiₓVSe₂ (0<x≦1), LiₓNiPS₂ (0<x≦1.5), LiₓFePS₂ (0<x≦1.5), a mixture of two or more thereof and a mixture of the compound IIIb with the solid IIIa; and the mixture I additionally contains from 0.1 to 20% by weight, based on the mixture II, of conductive carbon black.

4. A process as claimed in claim 1, wherein the pigment III is a compound IIIc which is capable of accepting lithium ions on charging and is selected from the group consisting of lithium, a lithium-containing metal alloy, micronized carbon black, natural and synthetic graphite, synthetically graphitized carbon dust, a carbon fiber, titanium oxide, zinc oxide, tin oxide, molybdenum oxide, tungsten oxide, titanium carbonate, molybdenum carbonate, zinc carbonate, a mixture of two or more thereof and a mixture of the compound IIIc with the solid IIIa; and the mixture I additionally contains up to 20% by weight, based on the mixture II, of conductive carbon black.

5. A process as claimed in claim 1, wherein the mixture I is crosslinked during or after the extrusion of the melt.

6. A process as claimed in claim 1, wherein the mixture is extruded in molten form in an apparatus which is selected from the group consisting of a single-screw plasticating extruder, a twin-screw extruder of the corotating type, a twin-screw extruder of the counterrotating type, a continuous twin-screw kneader and a continuous multiscrew extruder and a combination of two or more thereof.

7. A process for the production of a composite, which comprises the following stages:
(I) production of at least one first layer by compounding and extruding the melt of a mixture I as defined in claim 1, which comprises a mixture II which contains a solid IIIb or a solid IIIc as defined in claim 3 and 4, respectively;
(II) production of at least one second layer by compounding and extruding the melt of a mixture I as defined in claim 1, which comprises a mixture II which contains a solid IIIa, as defined in claim 2, and is free of a solid IIIb or a solid IIIc, and
(III) subsequent combination of the one or more first layers with the one or more second layers by a conventional coating method.

8. A molding, preferably a film-like molding, obtainable by a process which comprises the following stage:
I) Compounding and extruding the melt of a mixture I which comprises a mixture II which contains:
a) from 1 to 95% by weight of at least one pigment III which has a primary particle size of from 5 nm to 20 μm and is selected from the group consisting of an electrochemically inert solid IIIa, a compound IIIb capable of releasing lithium ions on charging and a compound IIIc capable of accepting lithium ions on charging and a mixture of the solid IIIa with the compound IIIb or the compound IIIc,
b) from 5 to 99% by weight of at least one copolymer IV of vinylidene fluoride (VdF) and hexafluoropropylene (HFP) containing from 8 to 25% by weight of HFP and
c) from 1 to 200% by weight, based on the total amount of the components a) and b), of a plasticizer V which is selected from the group consisting of dibutyl phthalate, dimethyl phthalate, diethyl phthalate, tris(butoxyethyl) phosphate, propylene carbonate, ethylene carbonate, trimethyl trimellitate and mixtures of two or more thereof,
the proportion of the mixture II in the mixture I being from 1 to 100% by weight.

9. A composite obtainable by a process which comprises the following stages:
(I) production of at least one first layer by compounding and extruding the melt of a mixture I as defined in claim 1, which comprises a mixture II which contains a solid IIIb or a solid IIIc as defined in claim 3 and 4, respectively;
(II) production of at least one second layer by compounding and extruding the melt of a mixture I as defined in claim 1, which comprises a mixture II which contains a solid IIIa, as defined in claim 2, and is free of a solid IIIb or a solid IIIc, and
(III) subsequent combination of the one or more first layers with the one or more second layers by a conventional coating method.

10. A process for the production of a solid electrolyte, of a separator, of an electrode, a sensor, an electrochromic window, a display, a capacitor or an ion-conducting film comprising the incorporation of a molding as claimed in claim 8.

11. A separator, solid electrolyte, electrode, sensor, electrochromic window, display, capacitor or ion-conducting film comprising a molding as claimed in claim 8.

12. An electrochemical cell comprising a separator, a solid electrolyte or an electrode as claimed in claim 11 or a combination of two or more thereof.

13. Car battery, apparatus battery or flat-type battery comprising an electrochemical cell as claimed in claim 12.
